(19) United States
(12) Patent Application Publication
(10) Pub. No.: US 2014/0147704 A1
(43) Pub. Date: May 29, 2014

(54) RECHARGEABLE BATTERY AND RECHARGEABLE BATTERY PACK INCLUDING THE SAME

(71) Applicant: SAMSUNG SDI CO., LTD., Yongin-si (KR)

(72) Inventor: Sae-Weon ROH, Yongin-si (KR)

(73) Assignee: SAMSUNG SDI CO., LTD., Yongin-si (KR)

(21) Appl. No.: 13/792,934

(22) Filed: Mar. 11, 2013

(30) Foreign Application Priority Data
Nov. 27, 2012 (KR) 10-2012-0135559

(51) Int. Cl. H01M 2/02

(52) U.S. Cl. CPC H01M 2/028
USPC 429/7; 429/185; 429/178

(57) ABSTRACT

A rechargeable battery includes an electrode assembly including a first electrode plate, a second electrode plate, and a separator between the first and second electrode plates, a can having a hexahedral shape with one opened side to accommodate the electrode assembly therein, the can further including a first side surface and a second side surface, the second side surface being opposite to the first side surface, a cap plate sealing the opened side of the can, and an insulation film attached to at least one side surface selected from the first side surface and the second side surface.

### CROSS-REFERENCE TO RELATED PATENT APPLICATION

The present application claims priority under 35 U.S.C. §119 to Korean Patent Application No. 10-2012-0135559, filed on Nov. 27, 2012, in the Korean Intellectual Property Office, and entitled: “Rechargeable Battery and Rechargeable Battery Pack Including the Same,” which is incorporated by reference herein in its entirety.

### BACKGROUND

1. Field

Embodiments relate to a rechargeable battery and a rechargeable battery pack including the same.

2. Description of the Related Art

With the development of wireless internet and communication technologies, mobile phones and portable computers, which are operated by using batteries instead of a power supply apparatus, have quickly come into widespread use. Generally, since mobile phones or portable computers are compact enough to carry easily, the mobile phones or portable computers may be being widely used for business or personal use.

### SUMMARY

Embodiments are directed to a rechargeable battery, including an electrode assembly including a first electrode plate, a second electrode plate, and a separator between the first and second electrode plates, a can having a hexahedral shape with one opened side to accommodate the electrode assembly therein, the can including a first side surface and a second side surface, the second side surface being opposite to the first side surface, a cap plate sealing the opened side of the can, and an insulation film attached to at least one side surface selected from the first side surface and the second side surface.

The can may be formed of a metallic material.

An electrode terminal that is electrically connected to the first electrode plate may be on the cap plate. The cap plate may be electrically connected to the second electrode plate.

The can may further include a front surface and a rear surface. The insulation film may cover the at least one side surface and portions of the front surface and the rear surface of the can that are adjacent and/or substantially perpendicular to the side surface.

The insulation film may include a first portion covering the at least one side surface, a second portion on one side of the first portion and bent from the first portion, and a third portion on an opposite side of the first portion from the second portion, the third portion being bent from the first portion.

The second portion may cover part of the front surface of the can, and the third portion covers part of the rear surface of the can.

Embodiments are also directed to a rechargeable battery including an electrode assembly including a first electrode plate having a first polarity, a second electrode plate having a second polarity, and a separator between the first and second electrode plates, a can having a hexahedral shape with an opened top portion to accommodate the electrode assembly therein, a cap plate sealing the opened top portion of the can, the cap plate having a same polarity as the second electrode plate, an electrode terminal on the cap plate, the electrode terminal having a same polarity as the first electrode plate, a first insulation film covering at least a first side surface of the can, and a second insulation film covering at least a second side surface of the can, the second side surface being opposite to the first side surface.

The can may include a metallic material and may have the same polarity as the cap plate.

The first insulation film may be attached to the first side surface of the can and portions of front and rear surfaces of the can that are adjacent and/or substantially perpendicular to the first side surface of the can.

The second insulation film may be attached to the second side surface of the can and portions of front and rear surfaces of the can that are adjacent and/or substantially perpendicular to the second side surface of the can.

Embodiments are also directed to a rechargeable battery pack including a plurality of rechargeable batteries disposed side-by-side in one direction such that side surfaces thereof face each other, a protection circuit module that is electrically connected to the plurality of rechargeable batteries, and a case accommodating the rechargeable batteries and the protection circuit module. Each of the rechargeable batteries includes an electrode assembly including a first electrode plate, a second electrode plate, and a separator between the first and second electrode plates, a can having a hexahedral shape with an opened side to accommodate the electrode assembly therein, the can including a second side surface, the second side surface being opposite to the first side surface, a cap plate sealing the opened side of the can, and an insulation film attached to at least one side surface selected from the first side surface and the second side surface.

The can and the cap plate of each of the rechargeable batteries may include a metallic material and may have the same polarity as the second electrode plate.

Each rechargeable battery may include an electrode terminal on the cap plate, the electrode terminal being electrically connected to the first electrode plate.

The plurality of rechargeable batteries may be disposed side-by-side in the one direction such that the electrode terminals of the rechargeable batteries are disposed on the same plane.

The can of each of the rechargeable batteries may include a metallic material,

With respect to each of the rechargeable batteries, the insulation film may have a first portion covering the at least one side surface selected from the first side surface and the second side surface, a second portion on one side of the first portion and bent from the first portion, and a third portion on an opposite side of the first portion from the second portion, the third portion being bent from the first portion.

With respect to each of the rechargeable batteries, the insulation film may cover the at least one side surface selected from the first side surface and the second side surfaces and portions of front and rear surfaces of the can that are adjacent and/or substantially perpendicular to the at least one side surface of the can.

With respect to each of the rechargeable batteries, the insulation film may include a first insulation film covering at least a first side surface of the can, and a second insulation film covering at least a second side surface of the can.

The first insulation film may cover only the first side surface of the can and portions of front and rear surfaces of the can that are adjacent and/or substantially perpendicular to the first side surface of the can.

The second insulation film may cover only the second side surface of the can and portions of front and rear surfaces of the can that are adjacent and/or substantially perpendicular to the second side surface of the can.

### BRIEF DESCRIPTION OF THE DRAWINGS

Features will become apparent to those of skill in the art by describing in detail exemplary embodiments with reference to the attached drawings in which:

FIG. 1 illustrates a schematic perspective view of a rechargeable battery according to an embodiment;

FIG. 2 illustrates an exploded perspective view of the rechargeable battery of FIG. 1;

FIG. 3 illustrates a cross-sectional view of an upper portion of FIG. 1 taken along line III-III;

FIG. 4 illustrates a schematic exploded perspective view of a battery pack including the rechargeable battery of FIG. 1; and

FIG. 5 illustrates a top view of a plurality of rechargeable batteries provided in the rechargeable battery pack of FIG. 4.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. Like reference numerals refer to like elements throughout.

Relational terms such as ‘first’, ‘second’, and the like may be used for describing various elements, but the elements should not be limited by the terms. The terms are used solely for distinguishing one element from another. In the following description, the technical terms are used only for explain a specific exemplary embodiment while not limiting the present invention. The terms of a singular form may include plural forms unless referred to the contrary. The meaning of “include”, “comprise”, “including”, or “comprising” specifies a property, a figure, a process, an operation, a component, a part, or combinations thereof but does not exclude other properties, figures, processes, operations, components, parts, or combinations thereof. The reference symbol “/” used herein may be situationally construed as “and” or “or”.

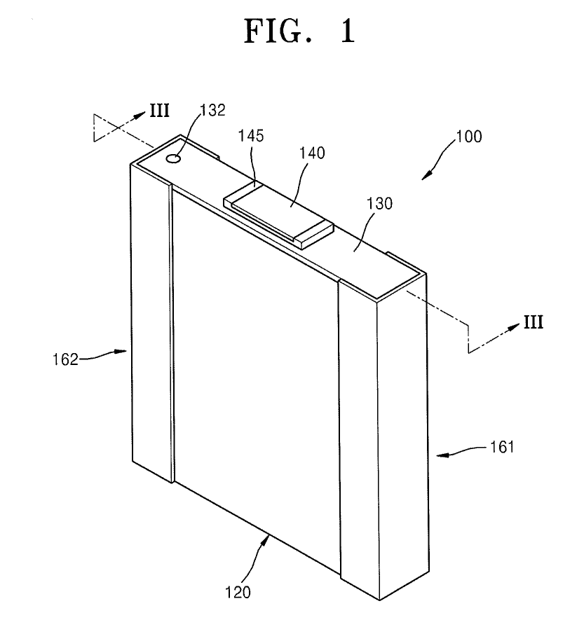

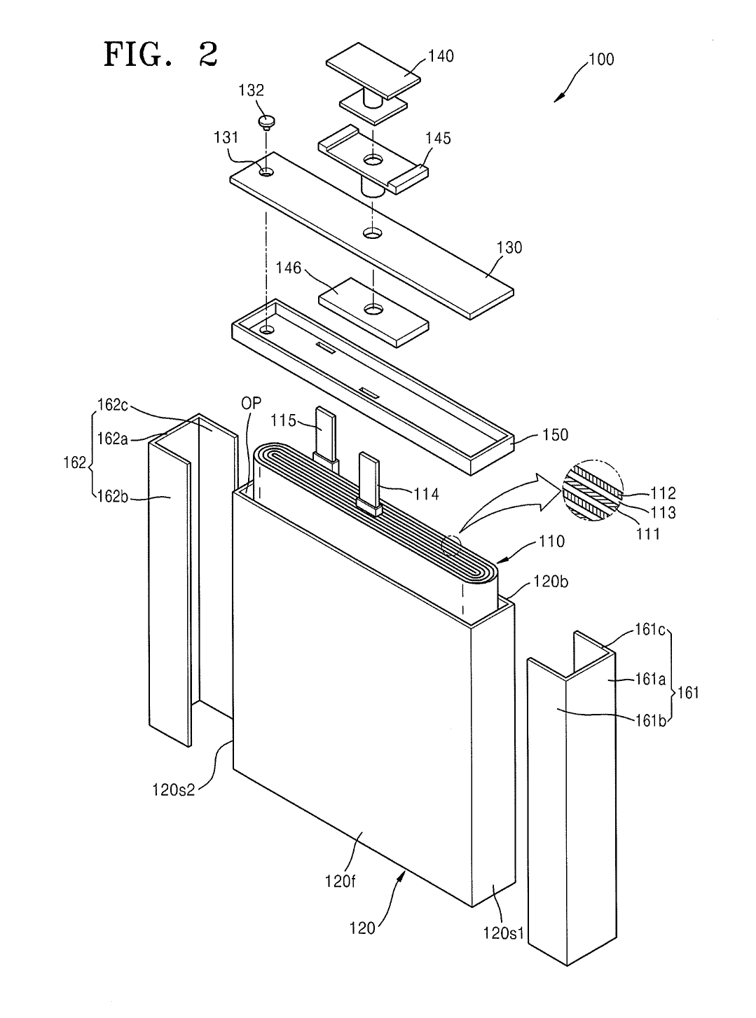

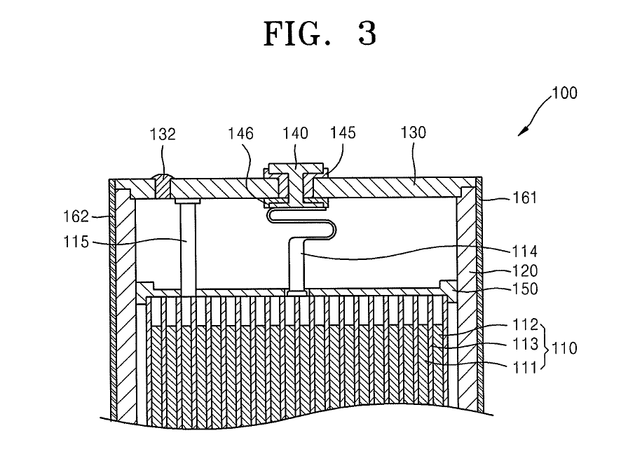

FIG. 1 illustrates a schematic perspective view of a rechargeable battery 100 according to an embodiment. FIG. 2 is an exploded perspective view of the rechargeable battery 100 of FIG. 1. FIG. 3 is a cross-sectional view of an upper portion of FIG. 1 taken along line III-III.

Referring to FIGS. 1 and 2, the rechargeable battery 100 according to an embodiment may include an electrode assembly 110, a can 120 accommodating the electrode assembly 110, a cap plate 130 sealing the inside of the can 120, and at least one of first and second insulation films 161 and 162 disposed at respective sides of the can 120.

The electrode assembly 110 may include first and second electrode plates 111 and 112 coated with an electrode active material and a separator 113 disposed between the first and second electrode plates 111 and 112. A stacked body in which the first electrode plate 111, the separator 113, and the second electrode plate 112 are sequentially stacked may be manufactured first, and then the stacked body may be wound in a jelly-roll shape to manufacture the electrode assembly 110. The first and second electrode plates 111 and 112 may be electrically connected to first and second electrode tabs 114 and 115, respectively, so that charges generated by a chemical reaction are extracted to the outside through the first and second electrode tabs 114 and 115. The first and second electrode tabs 114 and 115 may extend in the same direction. For example, the first and second electrode tabs 114 and 115 may extend outside an opening OP of the can 120.

Although the electrode assembly 110 has a jelly-roll shape in the current embodiment, other configurations are possible. For example, the electrode assembly 110 may have a stacked structure in which the first electrode plate 111, the second electrode plate 112, and the separator 113 disposed between the first and second electrode plates 111 and 112 are stacked on each other.

The can 120 may have a hexahedral shape with one opened surface. The can 120 may be formed of a metallic material having electrical conductivity. The electrode assembly 110, which is immersed in an electrolyte, may be accommodated within the can 120. After the electrode assembly 110 is accommodated within the can 120, the opening OP may be sealed by the cap plate 130. The cap plate 130 and the can 120 may be coupled to each other by using laser welding to seal the inside of the can 120.

The cap plate 130 may have an electrolyte injection hole 131. After the cap plate 130 and the can 120 are coupled to each other, the electrolyte may be injected through the electrolyte injection hole 131. The electrolyte injection hole 131 may be sealed by a plug 132. In other implementations, the electrolyte injection hole 131 may be omitted. In this case, the electrolyte may be injected before the cap plate 130 and the can 120 are integrally coupled to each other. The cap plate 130 and the can 120 may be integrally coupled by using laser welding.

An electrode terminal 140 may be disposed on the cap plate 130. The electrode terminal 140 may have a top surface exposed to the outside at an upper portion of the cap plate 130 and a lower portion passing through the cap plate 130 to extend toward the inside of the can 120.

Like the can 120, the cap plate 130 may be formed of a metallic material having electrical conductivity. As shown in FIG. 3, the electrode terminal 140 may be electrically connected to the first electrode tab 114 of the electrode assembly 110 to have a first polarity. The cap plate 130 may be electrically connected to the second electrode tab 115 of the electrode assembly 110 to have a second polarity. The can 120 that is connected to the cap plate 130 through the welding may have the second polarity.

For example, the cap plate 130 may serve as a positive electrode of the rechargeable battery 100, and the electrode terminal 140 may serve as a negative electrode of the rechargeable battery 100. First and second gaskets 145 and 146 formed of an insulation material may be disposed between the cap plate 130 and the electrode terminal 140 to prevent the cap plate 130 and the electrode terminal 140 from being short-circuited with each other. The first gasket 145 may contact a top surface of the cap plate 130, and the second gasket 146 may contact a bottom surface of the cap plate 130. Although the first and second gaskets 145 and 146 shown in FIG. 2 as being provided as separate members, in other implementations, the first and second gaskets 145 and 146 may be integrated with each other.

An insulation material 150 may be disposed above the electrode assembly 110 within the can 120. The insulation material 150 may insulate the electrode assembly 110 from the cap plate 130. In other implementations, the insulation material 150 may insulate the electrode assembly 110 from the cap plate 130 as well as restrict movement of the electrode assembly 110 within the can 120. The insulation material 150 may have through holes so that the first and second electrode tabs 114 and 115 may extend outside the opening OP. Although the insulation material 150 is shown as being disposed within the can 120 in the current embodiment, in other implementations, the insulation material 150 may be omitted.

The first and second insulation films 161 and 162 may be disposed on at least one side or both sides of the can 120. For example, the first insulation film 161 may be disposed on a first side, and the second insulation film 162 may be disposed on a second side of the can 120 that is opposite to the first side. For example, the first insulation film 161 may be attached to a first side surface 120s1 of the can 120, and the second insulation film 162 may be attached to a second side surface 120s2 of the can 120.

Each of the first and second insulation films 161 and 162 may be an adhesive tape having an adhesive on one surface thereof. The first and second insulation films 161 and 162 may be attached to the can 120 to cover the entire first side surface and the entire second side surface of the can 120, respectively.

The first insulation film 161 may be attached to cover the first side surface 120s1 of the can 120 and portions of a front surface 120f and a rear surface 120b of the can 120, which are approximately vertically bent with respect to the first side surface 120s1. For example, a first portion 161a of the first insulation film 161 may be attached to the first side surface 120s1, and second and third portions 161b and 161c, which are bent with respect to the first portion 161a, may be respectively attached to the front and rear surfaces 120f and 120b of the can 120.

The second insulation film 162 may be attached to cover the second side surface 120s2 of the can 120 and portions of the front surface 120f and the rear surface 120b of the can 120, which are approximately vertically bent with respect to the second side surface 120s2 of the can 120. For example, a first portion 162a of the second insulation film 162 may be attached to the second side surface 120s2, and second and third portions 162b and 162c, which are bent with respect to the first portion 162a, may be respectively attached to the front and rear surfaces 120f and 120b of the can 120.

The first and second insulation films 161 and 162 are attached to the side surfaces 120s1 and 120s2 and portions of the front and rear surfaces 120f and 120b of the can 120. The cap plate 130 and a bottom surface of the can 120 disposed on a side opposite to that of the cap plate 130 may be left uncovered by the first and second insulation films 161 and 162, and thus, may be exposed to the outside.

As described above, the first electrode tab 114 may be electrically connected to the electrode terminal 140. Accordingly, the electrode terminal 140 may have the first polarity. Each of the can 120 and the cap plate 130 is formed of a metallic material, and the second electrode tab 115 may be electrically connected to the electrode assembly 110. Accordingly, each of the can 120 and the electrode assembly 110 may have the second polarity. In an implementation, the first and second insulation films 161 and 162 may be attached to both side surfaces of the can 120 to insulate both side surfaces of the can 120.

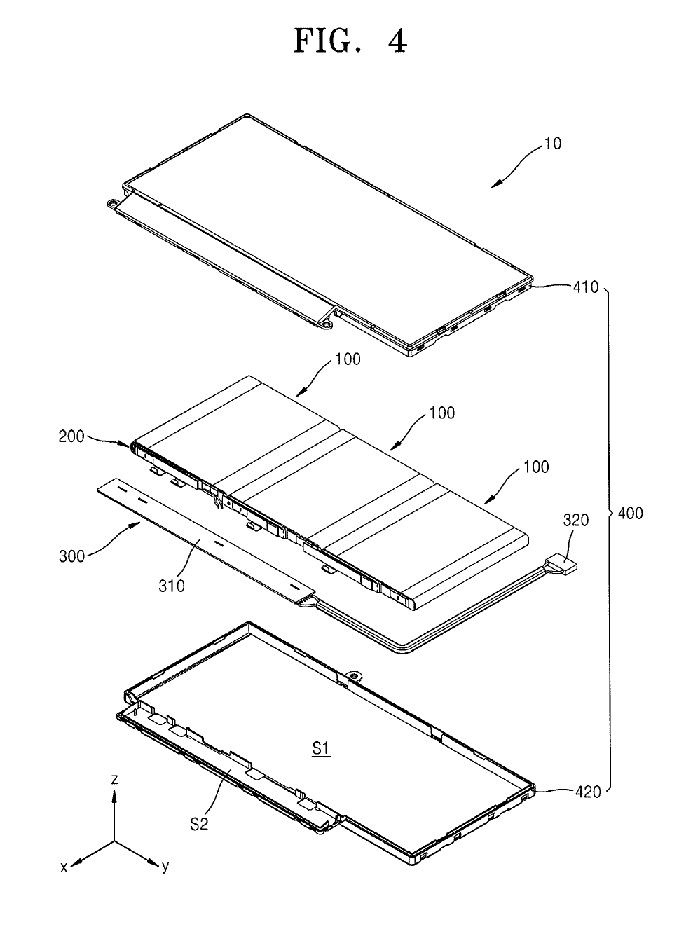

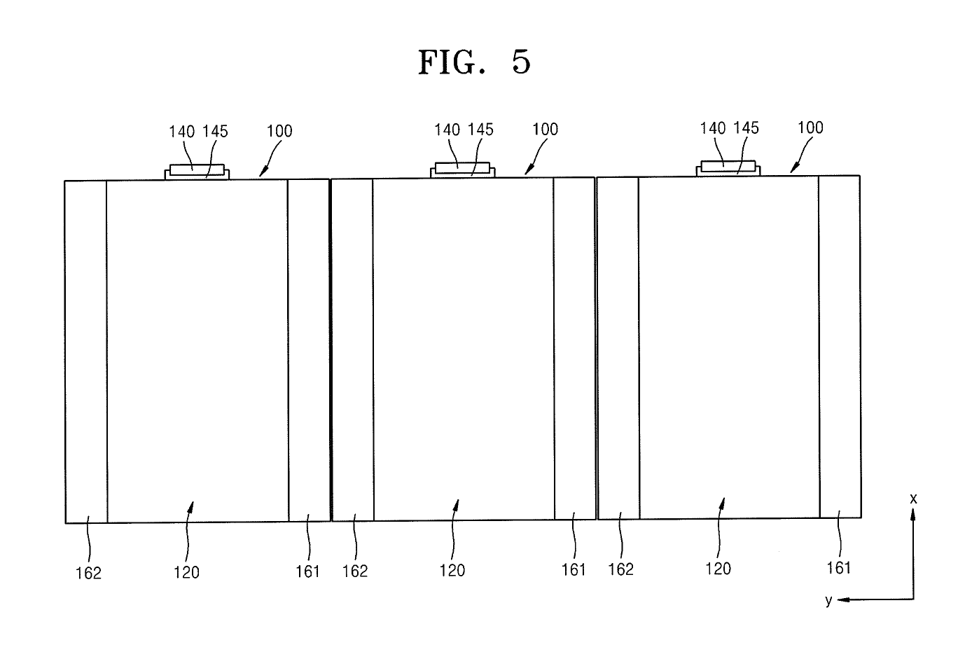

FIG. 4 illustrates a schematic exploded perspective view of a rechargeable battery pack 10 according to an embodiment, and FIG. 5 is a top view of a plurality of rechargeable batteries 100 provided in the rechargeable battery pack 10 of FIG. 4.

Referring to FIGS. 4 and 5, the battery pack 10 may include a case 400, the plurality of rechargeable batteries 100, and a protection circuit module 300.

Each of the plurality of rechargeable batteries 100 may have the same structure as that illustrated in FIGS. 1 to 3. The rechargeable batteries 100 may be disposed side-by-side along a lateral direction. Each of the rechargeable batteries 100 may be disposed so that the electrode terminals 140 are exposed in the same direction. Each of the rechargeable batteries 100 may be disposed so that the electrode terminals 140 are disposed on a same plane. The plurality of rechargeable batteries 100 may be connected to each other in series by a lead plate 200.

The protection circuit module 300 may be electrically connected to the plurality of rechargeable batteries 100. The protection circuit module 300 may prevent the rechargeable batteries 100 from exploding due to overcharging, overdischarging, or overcurrent of the rechargeable batteries 100, or may reduce the likelihood of such. The protection circuit module 300 may include a substrate 310 and a protection element (not shown) that is mounted on or inside of the substrate 310. The protection element may selectively include a safety element such as a passive element, e.g., a resistor or a capacitor and an active element, e.g., a field effect transistor (FET), and integrated circuits. A connector 320 that is electrically connected to an electrode terminal of an external device may be disposed on a side of the protection circuit module 300. The case 400 may accommodate the plurality of rechargeable batteries 100 and the protection circuit module 300. The case 400 may be formed of an insulation material to prevent or hinder the rechargeable batteries 100 from being unnecessarily electrically connected to external materials. For example, the case 400 may be a plastic molded case.

The case 400 may include an upper case 410 and a lower case 420. The upper case 410 and the lower case 420 may be coupled to each other through a hook structure disposed along a side surface thereof. The lower case 420 may have a first space S1 in which the rechargeable batteries 100 are disposed and a second space S2 in which the protection circuit module 300 is disposed.

The plurality of rechargeable batteries 100 accommodated in the first space S1 of the lower case 420 may be disposed side-by-side along a lateral direction. The adjacent rechargeable batteries 100 may be insulated by the first and second insulation films 161 and 162. Therefore, unnecessary short circuit between the adjacent rechargeable batteries 100 may be hindered or prevented.

Referring to FIG. 5, the electrode terminals 140 of the rechargeable batteries 100 may be exposed in the same direction so that the rechargeable batteries 100 may be electrically connected to each other by the lead plate 200 (see FIG. 4). For this, the rechargeable batteries 100 may be disposed side-by-side along the lateral direction. The adjacent rechargeable batteries 100 may be disposed so that side surfaces of the rechargeable batteries 100 face each other. The first and second insulation films 161 and 162 may be attached to the side surfaces of the rechargeable batteries 100. Accordingly, the adjacent rechargeable batteries 100 may be electrically insulated from each other.

The first insulation film 161 and the second insulation film 162 may be attached to cover the first and second side surfaces 120s1 and 120s2 of the rechargeable battery 100 as well as portions of the front surface 120f and the rear surface 120b of the rechargeable battery 100. Accordingly the first insulation film 161 and the second insulation film 162 may effectively prevent or hinder the short-circuiting of adjacent rechargeable batteries 100 with each other.

By way of summation and review, in order to use a mobile device in various places regardless the availability of a power supply, a mobile phone may include a rechargeable battery. Also, a portable computer may include an internal/external rechargeable battery pack. The internal/external rechargeable battery pack may include a plurality of rechargeable batteries that are repeatedly chargeable or dischargeable. The plurality of rechargeable batteries may be connected in series or/and in parallel. It is desirable that the rechargeable batteries be connected without an unnecessary short circuit.

According to the embodiment, an insulation film may be attached to cover at least one side surface of both side surfaces of the rechargeable battery. Accordingly, the insulation film may prevent a rechargeable battery from being short-circuited with external material or with an adjacent rechargeable battery.

Example embodiments have been disclosed herein, and although specific terms are employed, they are used and are to be interpreted in a generic and descriptive sense only and not for purpose of limitation. Accordingly, it will be understood by those of skill in the art that various changes in form and details may be made without departing from the spirit and scope thereof, as set forth in the following claims.

What is claimed is:

1. A rechargeable battery, comprising:
an electrode assembly including a first electrode plate, a second electrode plate, and a separator between the first and second electrode plates;
a can having a hexahedral shape with one opened side to accommodate the electrode assembly therein, the can including a first side surface and a second side surface, the second side surface being opposite to the first side surface;
a cap plate sealing the opened side of the can; and
an insulation film attached to at least one side surface selected from the first side surface and the second side surface.

2. The rechargeable battery as claimed in claim 1, wherein the can is formed of a metallic material.

3. The rechargeable battery as claimed in claim 1, wherein:
an electrode terminal that is electrically connected to the first electrode plate is on the cap plate, and
the cap plate is electrically connected to the second electrode plate.

4. The rechargeable battery as claimed in claim 1, wherein:
the can further includes a front surface and a rear surface, and
the insulation film covers the at least one side surface and portions of the front surface and the rear surface of the can that are adjacent to the side surface.

5. The rechargeable battery as claimed in claim 1, wherein the insulation film includes a first portion covering the at least one side surface, a second portion on one side of the first portion and bent from the first portion, and a third portion on an opposite side of the first portion from the second portion, the third portion being bent from the first portion.

6. The rechargeable battery as claimed in claim 5, wherein the second portion covers part of the front surface of the can, and the third portion covers part of the rear surface of the can.

7. A rechargeable battery, comprising:
an electrode assembly including a first electrode plate having a first polarity, a second electrode plate having a second polarity, and a separator between the first and second electrode plates;
a can having a hexahedral shape with an opened top portion to accommodate the electrode assembly therein;
a cap plate sealing the opened top portion of the can, the cap plate having a same polarity as the second electrode plate;
an electrode terminal on the cap plate, the electrode terminal having a same polarity as the first electrode plate;
a first insulation film covering at least a first side surface of the can; and
a second insulation film covering at least a second side surface of the can, the second side surface being opposite to the first side surface.

8. The rechargeable battery as claimed in claim 7, wherein the can includes a metallic material and has the same polarity as the cap plate.

9. The rechargeable battery as claimed in claim 8, wherein the first insulation film is attached to the first side surface of the can and portions of front and rear surfaces of the can that are adjacent to the first side surface of the can.

10. The rechargeable battery as claimed in claim 8, wherein the second insulation film is attached to the second side surface of the can and portions of front and rear surfaces of the can that are adjacent to the second side surface of the can.

11. A rechargeable battery pack, comprising:
a plurality of rechargeable batteries disposed side-by-side in one direction such that side surfaces thereof face each other;
a protection circuit module that is electrically connected to the plurality of rechargeable batteries; and
a case accommodating the rechargeable batteries and the protection circuit module,
wherein each of the rechargeable batteries comprises:
an electrode assembly including a first electrode plate, a second electrode plate, and a separator between the first and second electrode plates;
a can having a hexahedral shape with an opened side to accommodate the electrode assembly therein, the can including a first side surface and a second side surface, the second side surface being opposite to the first side surface;
a cap plate sealing the opened side of the can; and
an insulation film attached to at least one side surface selected from the first side surface and the second side surface.

12. The rechargeable battery pack as claimed in claim 11, wherein the can and the cap plate of each of the rechargeable batteries include a metallic material and have the same polarity as the second electrode plate.

13. The rechargeable battery pack as claimed in claim 11, wherein each rechargeable battery includes an electrode terminal on the cap plate, the electrode terminal being electrically connected to the first electrode plate.

14. The rechargeable battery pack as claimed in claim 13, wherein the plurality of rechargeable batteries are disposed side-by-side in the one direction such that the electrode terminals of the rechargeable batteries are disposed on the same plane.

15. The rechargeable battery pack as claimed in claim 13, wherein the can of each of the rechargeable batteries includes a metallic material.

16. The rechargeable battery pack as claimed in claim 11, wherein, with respect to each of the rechargeable batteries, the insulation film has a first portion covering the at least one side surface selected from the first side surface and the second side surface, a second portion on one side of the first portion and bent from the first portion, and a third portion on an opposite side of the first portion from the second portion, the third portion being bent from the first portion.

17. The rechargeable battery pack as claimed in claim 11, wherein, with respect to each of the rechargeable batteries, the insulation film covers the at least one side surface selected from the first side surface and the second side surfaces and portions of front and rear surfaces of the can that are adjacent to the at least one side surfaces of the can.

18. The rechargeable battery pack as claimed in claim 11, wherein, with respect to each of the rechargeable batteries, the insulation film includes:
a first insulation film covering at least a first side surface of the can; and
a second insulation film covering at least a second side surface of the can.

19. The rechargeable battery pack as claimed in claim 18, wherein the first insulation film covers only the first side surface of the can and portions of front and rear surfaces of the can that are adjacent to the first side surface of the can.

20. The rechargeable battery pack as claimed in claim 18, wherein the second insulation film covers only the second side surface of the can and portions of front and rear surfaces of the can that are adjacent to the second side surface of the can.
